(19) United States
(12) Patent Application Publication
(10) Pub. No.: US 2012/0121822 A1
(43) Pub. Date: May 17, 2012

(54) MANUFACTURE METHOD FOR THIN FILM FRAME LAYER OF DISPLAY PANEL

(76) Inventor: Kai-Ti Yang, Taoyuan (TW)

(21) Appl. No.: 12/944,763

(22) Filed: Nov. 12, 2010

(51) Int. Cl. B05D 3/06; B08B 3/10; B05D 3/02; B05D 5/06; B05D 1/32

(52) U.S. Cl. 427/558; 427/164; 427/165

(57) ABSTRACT

In the manufacture method for thin film frame layer of display panel, a photoresist liquid is coated onto a high transparent flat substrate through a capillary pipe of a dispenser. A predetermined pattern of photoresist is formed onto the substrate through a predetermined relative motion of the dispenser and the substrate. A patterned photoresist layer is formed by solidifying the photoresist liquid. The dispenser includes a pump filled with photoresist liquid and at least one downward capillary pipe for pouring out the photoresist liquid from a spout of the capillary pipe. The photoresist liquid is a black negative photoresist liquid with viscosity between 2 to 10 cps, and the predetermined relative motion is a spiral path.

### FIELD OF THE INVENTION

The present invention relates to manufacture method for thin film frame layer of display panel, and particular to a manufacture method for forming a patterned thin film frame layer to a display panel by photoresist coating.

### DESCRIPTION OF THE PRIOR ART

Typical touch panels have a touch sensing device insulated arranged between a top plate and a substrate and conducting wires embedded around edges of the stacked plates for transmitting the signal to a signal processing circuit. Usually, a frame of a patterned thin film is formed around the edges of the touch panel for the purposes of the flatness of the touch panel and protection to the conducting wires. Most of above patterned layers are done by wet coating processes such as spin coating or slot coating which uniformly coating the substrate with photoresist. Spin coating method will spread photoresist around a substrate uniformly by high speed rotation of the substrate. However, a lot of factors need to be concerned for the process such as type of the phororesist and solution relative to final thickness of the film and the air flow vaporizing the liquid resulting in defects to the film. The uniformity of the film will be difficult to maintain with the growing of size of the substrate. Also, photoresist used for such process will be much more than needed. The slot coating can make great use of photoresist by using a squeezing nozzle to distribute photoresist supplied by a precision quantification pump. Nearly 100% usage of photoresist can be achieved by the process, but the precision of equipment also causes higher cost.

### SUMMARY OF THE PRESENT INVENTION

Accordingly, the primary object of the present invention is to provide a manufacture method for thin film frame layer of display panel for the purposes of improving usage of photoresist, simplifying manufacture process, and lowering cost. In addition, the pattern and the size of the coating won't be a problem for the uniformity of the coating. An identical optical density can be achieved so as to reduce color difference.

### BRIEF DESCRIPTION OF THE DRAWINGS

FIG. 1 is a schematic view showing an arrangement of a dispenser and a substrate of the present invention.

FIG. 2 is a schematic view showing a capillary pipe pouring out photoresist onto the substrate.

FIG. 3 is a top view showing a plurality of capillary pipe arranged in line to dispense photoresist.

FIG. 4 is a top view showing a plurality of capillary pipe arranged in matrix to dispense photoresist.

FIG. 5 is a schematic view showing a path of the dispenser of the present invention.

FIG. 6 is a schematic view showing another path of the dispenser of the present invention.

FIG. 7 is a schematic view showing a yet path of the dispenser of the present invention.

FIG. 8 is a schematic view showing an exposure of a photoresist pattern of the present invention.

FIG. 9 is a cross-section view showing a solidified photoresist pattern of the present invention.

FIG. 10 is a schematic view showing an exposure of a photoresist pattern of the present invention using a photo mask.

FIG. 11 is a schematic view showing sampling points of a photoresist thin film layer sample of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

A manufacture method for thin film frame layer of display panel according to the present invention is described in the following with appended drawings.

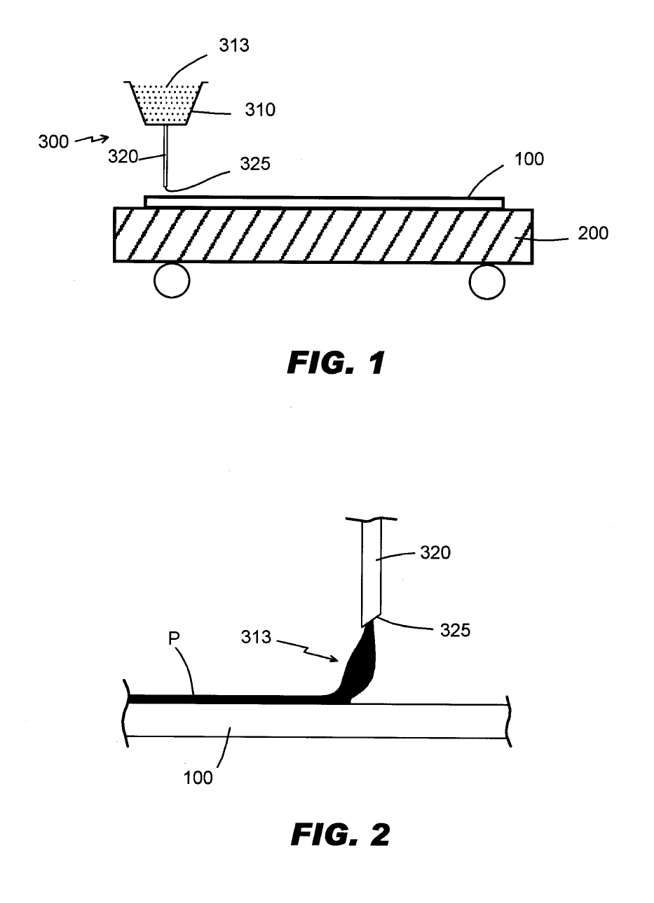

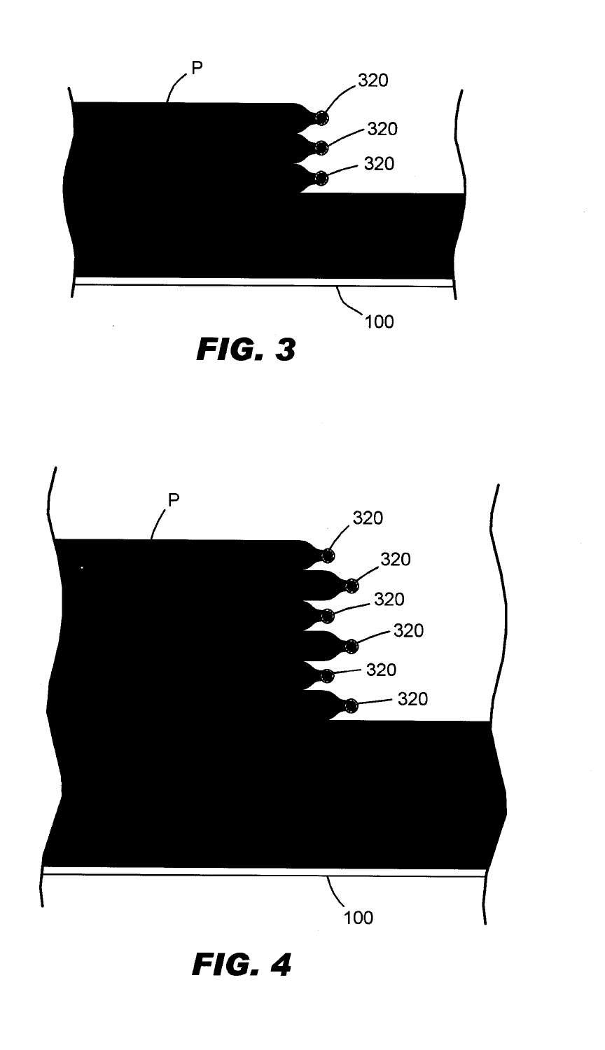

First, a flat substrate 100 is placed on a working platform 200. The substrate 100 is preferably a highly transparent plate with a contact angle of a cleaned surface thereof less than 10 degrees. In the embodiment, the substrate 100 is a glass. However, the substrate 100 could be selectively made of polycarbonate (PC), polyester (PET), polymethyl methacrylate (PMMA), or Cyclo-Olefin Copolymers (COC). The working platform 200 is moved below a dispenser 300. A distance of 3 mm is maintained between the surface of the substrate 100 and a spout 325 of the dispenser 300. Referring to FIG. 1, the dispenser 300 includes a pump 310 and a downward capillary pipe 320 made of stainless steel. The capillary pipe 320 has an inner diameter of 100 ∞m. The pump 310 is filled with specific photoresist liquid 313 which is a black negative photoresist such as polyisoprene with viscosity between 2 to 10 cps in the embodiment. The photoresist liquid 313 passing through the capillary pipe 320 and the spout 325 by the pressurizing of the pump 310 will be distributed onto the surface of the substrate 100 as shown in FIG. 2. The dispenser 300 can be equipped with multiple capillary pipes arranged in line (shown in FIG. 3) or in matrix (shown in FIG. 4) so as to raise efficiency and uniformity of the coating process.

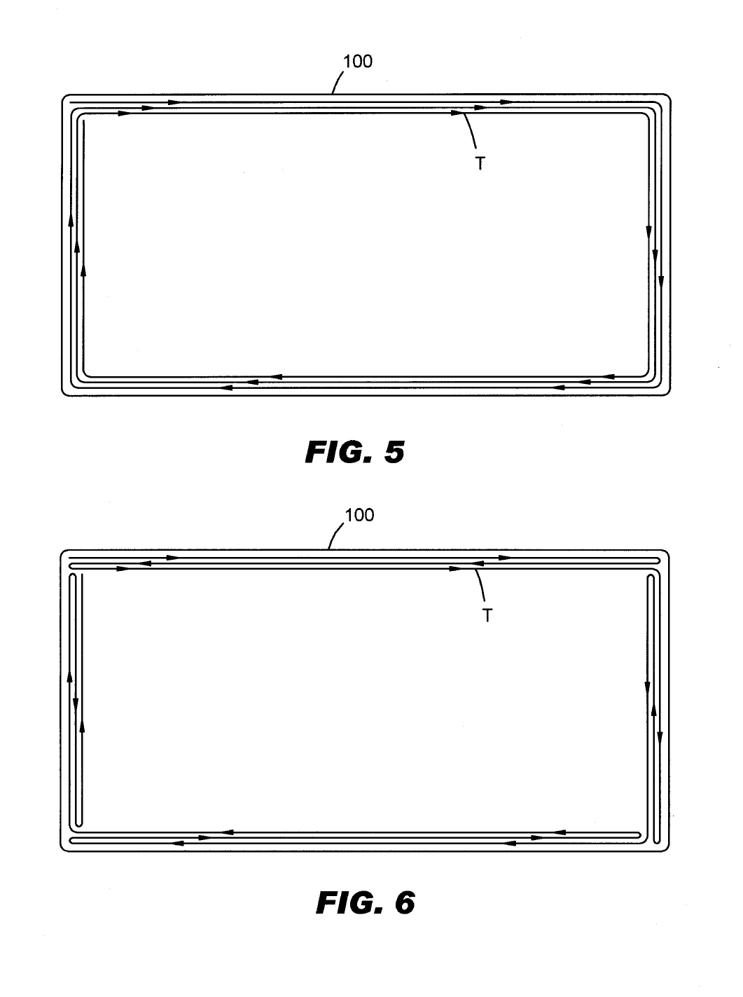

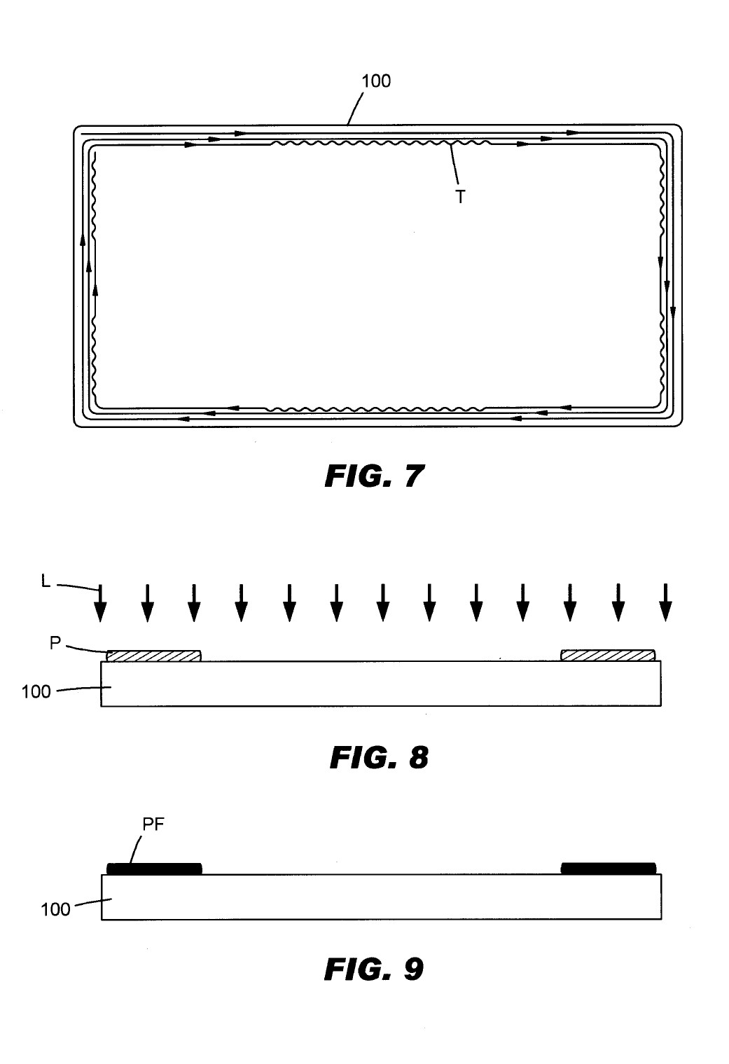

For the next step, the pump 310 will be pressurized by nitrogen of 1 Mpa so as to push the photoresist liquid 313 into the capillary pipe 320 and to the surface of the substrate 100 through the spout 325. In the same time, the working platform 200 will start to move along the predetermined path T so that the photoresist liquid can be coated onto the surface of the substrate as a predetermined pattern P (as shown in FIG. 2). In the present invention, the path T is an inward clockwise spiral track, the photoresist liquid 313 is dispensed from edges of the surface to inner area of the surface as shown in FIG. 5. The path can be differently arranged such as parallel stripes shown in FIG. 6, non-linear trace shown in FIG. 7, or another other geometric traces combination. Obviously, the path can be optimized depending on the desired pattern of the coating.

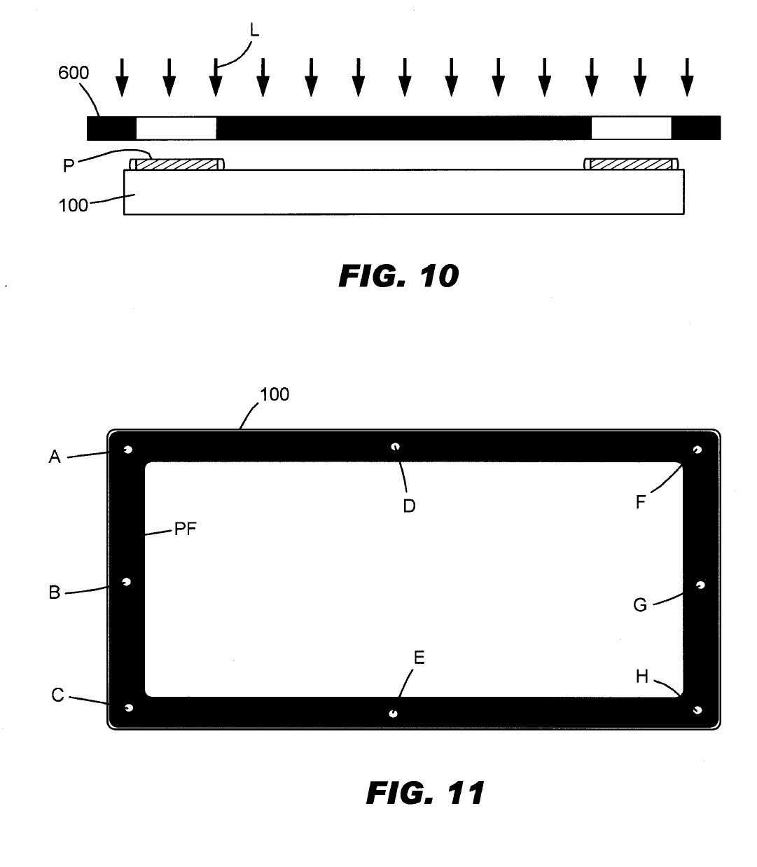

Finally, the last step is to solidify the photoresist liquid on the substrate 100 to form a film. This step further contains 3 steps list in the following.
1. Prebake is to bake the photoresist liquid on the substrate in a 80° C. baking oven for about 120 seconds and gently cool down to room temperature (about 25° C.) so as to increase the adhesion of the photoresist liquid to the surface of the substrate.
2. Exposure and developing is to expose all the photoresist pattern P to a 200 MJ/cm² ultraviolet light source L and spray 0.5 Kg/cm² developer (such as xylene) on the pattern P, the exposed photoresist pattern P becomes insoluble in the develop solution so that a solid photoresist film PF is formed as shown in FIG. 9.
Above exposure and developing is done without removing any part of the film, and 100% of photoresist is remained so that the cost is saved for the photoresist and relative processes for removal of photoresist. Most of thin film frame layer for touch panel can be formed by the above processes. However, a quartz photo mask 600 is needed while a complicated pattern of film is required as shown in FIG. 10. The photo mask is arranged between the light source L and the photoresist pattern P and is 50 μm away from the photoresist pattern. After developing and spraying of 0.5 Kg/cm² cleaner (such as N-Butyl Acetate or water), unexposed photoresist will be removed so that delicate thin film pattern layer can be formed on the substrate.
3. Post-bake is to bake the exposed and developed photoresist in a 230° C. baking oven for about 30 minutes to remove residue solvent in the photoresist so as to solidify the photoresist pattern.

A thin film frame layer can be formed around the edges of a display panel after above processes. An actual sampling for thickness and dynamic range of optical density is shown in the following table (sampling plan is shown in FIG. 11). An average thickness of the thin film is 1.45±0.01 μm, and an average optic density is 4.5±0.1.

| | Sample point | | | | | | | | | |
|---|---|---|---|---|---|---|---|---|---|---|
| | A | B | C | D | E | F | G | H | Average | Stdev |
| Thickness | 1.45 | 1.46 | 1.45 | 1.45 | 1.44 | 1.45 | 1.44 | 1.46 | 1.4500 | 0.0076 |
| (μm) | | | | | | | | | | |
| Optic | 4.5 | 4.4 | 4.6 | 4.5 | 4.6 | 4.5 | 4.6 | 4.5 | 4.5250 | 0.0707 |
| density | | | | | | | | | | |

[symbol]

A patterned thin film formed around the frame of the touch panel is formed according to the present invention for sheltering the conducting wires and ensuring a flatness of the touch panel.

Comparing with prior techniques in the field of touch panel industry, the present invention has the following advantages.
1. A usage of photoresist is almost 100% so that cost thereof can be saved. The photo mask for exposure is ignored and the processes for removal of photoresist pattern is no longer needed so that cost of manufacture is lowered.
2. The size of substrate and the pattern of coating are not limited.
3. A thickness of thin film pattern is uniform, and an identical optical density can be achieved to reduce color difference.
4. Manufacture is simplified so as to lower cost and improve yield.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A manufacture method for thin film frame layer of display panel comprising:
a highly transparent flat substrate;
a photoresist liquid being coated onto the substrate through a capillary pipe of a dispenser, and a predetermined pattern of the photoresist being formed onto the substrate by a relative motion of the dispenser and the substrate which is a predetermined path; and
solidifying the photoresist on the substrate so as to form a photoresist thin film layer.

2. The manufacture method for thin film frame layer of display panel as claimed in claim 1, wherein the transparent flat substrate is one of a soft, hard, or flexible transparent plate; the material of the substrate is one of glass, polycarbonate (PC), polyester (PET), polymethyl methacrylate (PMMA), or Cyclo-Olefin Copolymers (COC).

3. The manufacture method for thin film frame layer of display panel as claimed in claim 1, wherein the dispenser includes a pump filled with photoresist liquid and at least one downward capillary pipe; a perpendicular distance between a spout of the capillary pipe and the substrate is between 0.5 mm to 5 mm; the photoresist liquid is pressed into the capillary pipe by the pump so that the photoresist liquid is coated on a surface of the substrate continuously through the spout of the capillary pipe.

4. The manufacture method for thin film frame layer of display panel as claimed in claim 3, wherein the inner diameter of the capillary pipe is between 10 μm to 500 μm.

5. The manufacture method for thin film frame layer of display panel as claimed in claim 3, wherein the dispenser has a plurality of capillary pipe arranged in line or matrix.

6. The manufacture method for thin film frame layer of display panel as claimed in claim 1, wherein a viscosity of the photoresist liquid is between 2 to 10 cps.

7. The manufacture method for thin film frame layer of display panel as claimed in claim 1, wherein the photoresist is one of a color or black negative photoresist.

8. The manufacture method for thin film frame layer of display panel as claimed in claim 1, wherein the path is one of a spiral path, parallel back and forth line, non-linear trace, or geometric traces combination.

9. The manufacture method for thin film frame layer of display panel as claimed in claim 1, wherein the solidifying of the photoresist further includes:
a substrate having a negative photoresist pattern on a surface thereof;
prebaking the substrate in a 60° C. to 90° C. baking oven for 100 to 140 seconds and gently cooling down the substrate to room temperature;
exposing all the photoresist pattern to a 150 to 200 MJ/cm² ultraviolet light source and spraying 0.5 Kg/cm² developer on the pattern; and
post-baking the substrate in a 210° C. to 250° C. baking oven for 25 to 35 minutes so as to solidify the photoresist pattern as a thin film layer.

10. The manufacture method for thin film frame layer of display panel as claimed in claim 1, wherein the solidifying of the photoresist further includes:
a substrate having a negative photoresist pattern on a surface thereof;
prebaking the substrate in a 60° C. to 90° C. baking oven for 100 to 140 seconds and gently cooling down the substrate to room temperature;
exposing the photoresist pattern to a 150 to 200 MJ/cm² ultraviolet light source; a photo mask having a predetermined delicate pattern being arranged between the photoresist pattern and the light source; a gap of 30 μm to 80 μm being remained between the mask and the photoresist pattern so that the delicate pattern on the photo mask will be lithographed to the photoresist pattern;
developing the photoresist pattern by spraying 0.5 Kg/cm² developer on the photoresist pattern and removing the excess photoresist by spraying 0.5 Kg/cm² cleaner on the photoresist pattern; and
post-baking the substrate in a 210° C. to 250° C. baking oven for 25 to 35 minutes so as to solidify the photoresist pattern as a thin film layer.
